(19) United States
(12) Patent Application Publication
(10) Pub. No.: US 2011/0033276 A1
(43) Pub. Date: Feb. 10, 2011

(54) Handling device for moving goods

(75) Inventors: Alban Hutter, Reit im Winkl (DE); Pavel Chrzibek, Rosenheim (DE)

Correspondence Address: Davidson, Davidson & Kappel, LLC, 485 7th Avenue, 14th Floor, New York, NY, 10018, US

(73) Assignee: KRONES AG, Neutraubling (DE)

(21) Appl. No.: 12/804,938

(22) Filed: Aug. 2, 2010

(30) Foreign Application Priority Data
Aug. 4, 2009 (DE) DE102009026318.7

(51) Int. Cl. B65G 1/133

(52) U.S. Cl. 414/749.1

(57) ABSTRACT

A handling device (20) for moving goods (10). The handling device (20) is equipped with at least one tool holder (32) that can be moved by a first drive unit (24) and a second drive unit (25) in two spatial directions that are at an angle (12) with respect to each other. The at least one tool holder (32) is held between the first drive unit (24) and the second drive unit (25).

This claims priority to German Patent Application DE 10 2009 026 318.7, filed Aug. 4, 2009 and hereby incorporated by reference herein.

The present invention relates to a handling device for moving goods. The handling device is equipped with a first drive unit. This drive unit has a tool holder. The tool holder can be moved in two directions that are at an angle with respect to each other by means of two stationary axles in conjunction with a flexible, ribbon-shaped element.

### BACKGROUND

German utility model DE 94 17 837 discloses a device for moving objects, said device being driven by a flexible element. The systematic control of the motor-driven deflection rollers allows the gripping mechanism to be completely positioned in the Y and Z directions. As a result of this systematic control, a gripping mechanism can be guided to every position in the area of the gantry carrier. Moreover, the two motors needed for moving the gripping mechanism are installed so as to be stationary.

German patent application DE 100 17 293 A1 discloses a drive for positioning devices and/or objects over a surface in the X-Y direction or in the X-Z direction. The systematic actuation of the drive rollers allows the vertical cantilever arm to be moved on the horizontal cantilever arm either in the X direction or in the Y direction or in the Z direction. The movement in the X-Y direction or in the X-Z direction takes place according to the same principle as disclosed in German utility model DE 94 17 837.

German patent application DE 195 15 994 A1 discloses an automatic spatial gantry device, especially for transporting pressed car parts on pallets out of a multi-stage press for large parts. According to the invention, this automatic device has the following features: a first main axle that is driven by a first drive device, a second main axle that is driven by a second drive device that runs parallel to the first main axle, and a third main axle that is driven by a third drive device that runs approximately perpendicular to the plane enclosed by the other main axles. Furthermore, there is a movable gripping mechanism for gripping the parts that are to be transported. Each of the three drive devices has its own belt drive with a separate drive motor. The tool holder is articulated on two vertical supports that are each associated with one drive device.

European patent specification EP 1 210 214 B1 discloses a robot unit for transferring workpieces. The robot unit mainly serves to transfer objects in presses, for example, in the steel industry. The gripping units are articulated on a vertical support via two elongated units. In order to be able to move the vertical support in the X and/or Y direction, the robot unit is driven by two motors and via the drive wheels that interact with a flexible element (toothed belt). The gripping units can be positioned as a function of the running direction and the speed.

Japanese patent application JP 10272570 A discloses a gantry robot that is equipped with at least two welding units. The welding units can be moved in the X, Y and Z directions. Moreover, it is also possible to swivel the welding units themselves by 180°. In another embodiment, the gantry robot is equipped with four welding units that are each attached to a separate support and that can be moved in the X, Y and Z directions.

Japanese patent application JP 2003-305682 discloses a drive for a robot that can be moved in three axes. In order to move the robot over the desired axes, the drive is equipped with three motors that are each used for movement in one direction. Shafts, hollow shafts and gearwheels are employed in order to transmit the rotational movements of the motors to the drive units.

U.S. Pat. No. 7,344,017 B1 describes a machine that can be moved in three axes. A separate drive unit is provided to move the machine in each of the three directions of movement. Each of these drive units has a motor, at least one flexible element for transmitting the motor forces, and several deflection rollers. By appropriately controlling the machine, a workpiece can be moved to any point in the interior of the machine.

### SUMMARY OF THE INVENTION

It is an object of the present invention to put forward a handling device with which heavy loads can be securely moved and picked up and/or set down with pinpoint accuracy.

A handling device for moving goods is disclosed here. This handling device has a first drive unit and at least one tool holder. The at least one tool holder can be moved in two directions that are at an angle with respect to each other by means of two stationary axles in conjunction with a flexible, ribbon-shaped element. The at least one tool holder has a second drive unit. The at least one tool holder is held between the first drive unit and the second drive unit.

Several tool holders with their associated tools can be arranged in one handling device. For instance, two tool holders, each having two drive units parallel to each other, can be installed in the handling device. It is likewise possible to place the tool holder with the appertaining drive units in such a way that each tool covers an approximately equal work area. In another embodiment, a third tool carrier having a conventional drive unit known from German publication DE 94 17 837 can be connected on one side to the tool carrier. The entire arrangement is integrated into the handling device. The number of handling devices and their configuration depend on the space required by the individual components and on the packaging tasks that are to be performed by the handling device. Therefore, the above-mentioned list of embodiments should not be construed as a definitive limitation of the invention. The configuration of the drive units of the individual tool carriers can be varied as a function of the task envisaged for the articulated tool.

The flexible element can be, for instance, a webbed belt, a chain or another flat element that completely encircles the drive unit.

The movement of the tool holder is controlled analogously to the approach described in the publications DE 94 17 837 and DE 100 17 293 A1. When both drive motors are moved clockwise, the vertical cantilever arm is moved, for example, to the right. When both drive motors are moved counterclockwise, the vertical cantilever arm is moved to the left. A movement of both drive motors in opposite rotational directions moves the vertical cantilever arm upwards or downwards. These movements are made when the drive motors run at the same rotational speed. If, in addition to the rotational directions, the rotational speeds of the drive motors are also varied, it is possible to combine the horizontal and vertical movements.

The handling device has two stationary axles. According to a first embodiment, the first and the second drive units are connected to each other by means of a shared first shaft and a shared second shaft. The shared first shaft can be driven by a first motor and the shared second shaft can be driven by a second motor.

For purposes of coordinating the movement of the handling device in accordance with the above-mentioned embodiment, the first motor and the second motor can be regulated in terms of their rotational speed and rotational direction by means of a device. The at least one tool holder can be moved in two directions that are at an angle with respect to each other.

According to a second embodiment, the handling device has a first, a second and a third motor. In this context, the first stationary axle of the first drive unit and that of the second drive unit are connected to each other by means of a shared first shaft. The first shaft can be driven by the first motor. The second and third motors act on the second stationary axle, so that the first drive unit can be driven by the second motor, and the second drive unit can be driven by the third motor.

According to a further enhancement, the first motor as well as the motor pair make up the second motor and the third motor of the handling device can likewise be regulated by a device. The second motor and the third motor here can be additionally synchronized with the unit. The at least one tool holder can be moved in two directions that are at an angle with respect to each other.

According to a third embodiment, the handling device has a first, a second, a third and a fourth motor. The first motor and the second motor act on the first stationary axle and on the second stationary axle, respectively. The third motor and the fourth motor act on the second stationary axle and on the first stationary axle, respectively. The first drive unit can be driven by the first motor and by the second motor (26b). The second drive unit can be driven by the fourth and the third motors.

The handling device according to the above-mentioned embodiment is likewise regulated by the device that synchronizes the first and fourth motors of the first motor pair, and the second and third motors of the second motor pair. By the same token, the first and fourth motors of the first motor pair, and the second and third motors of the second motor pair are regulated in terms of their rotational speed and rotational direction. In this process, the at least one tool holder is moved in two directions that are at an angle with respect to each other.

Each of the two drive units of a tool holder is held on a first rail and on a second rail, respectively. The first and second rails are articulated on a frame of the handling unit.

In another embodiment, the handling device has at least two tool holders. Two drive units are associated with each of these tool holders.

It is likewise possible to install the drive units on the side supports of the frame. This possibility of mounting the drive unit would be used, for example, if two tool holders, together with the drive units associated with them, are to be installed in a handling unit. In this case, the drive units of the second tool holder would be articulated on the additional rails inside the frame. The drive units of the first tool holder are affixed to the side supports of the frame.

The tool holders of the handling device are configured in such a way that different tools can be interchangeably held there. These tools can be, for instance, suction devices, grippers, or else grippers that can rotate and/or move on the tool holder, etc. Various tools for handling goods are known from the state of the art. It is likewise known that the tools can be movably arranged on and/or around the tool holder in different ways. The tools are adapted depending on the goods that are to be moved. Consequently, the gripper types and the ways of moving the tools listed here are not to be construed as a definitive limitation of the invention.

Embodiments of the invention and its advantages will be explained in greater detail below on the basis of the accompanying figures. In the figures, the scales of the individual elements with respect to each other do not always correspond to their true scale since some shapes are shown in simplified form while other shapes are depicted in enlarged form relative to other elements for the sake of greater clarity.

### BRIEF DESCRIPTION OF THE DRAWINGS

FIG. 1 shows a perspective partial view of the structure of the handling device according to the invention;

FIG. 2 shows the schematic structure of a drive unit according to the state of the art;

FIG. 3 shows an exploded view of the frame of the handling device;

FIG. 4 shows a top view of a schematic structure of the handling device with two motors and one tool holder;

FIG. 5 shows a top view of a schematic structure of the handling unit with four motors and one tool holder;

FIG. 6 shows a top view of part of a handling unit with two drive units and one tool holder;

FIG. 7 shows a handling unit with four drive units and two tool holders;

FIG. 8 shows a top view of a handling device with one tool holder and three motors;

FIG. 9 shows a top view of the handling device from FIG. 7 with only six drive motors;

FIG. 10 shows a front view of a handling device with one tool holder.

### DETAILED DESCRIPTION

The same reference numerals are used for identical or functionally equivalent elements of the invention. Moreover, for the sake of clarity, the individual figures only have the reference numerals that are needed for the description of that particular figure. The embodiments shown are merely examples of how the handling device according to the invention can be configured, and they are not to be construed as a definitive limitation of the invention.

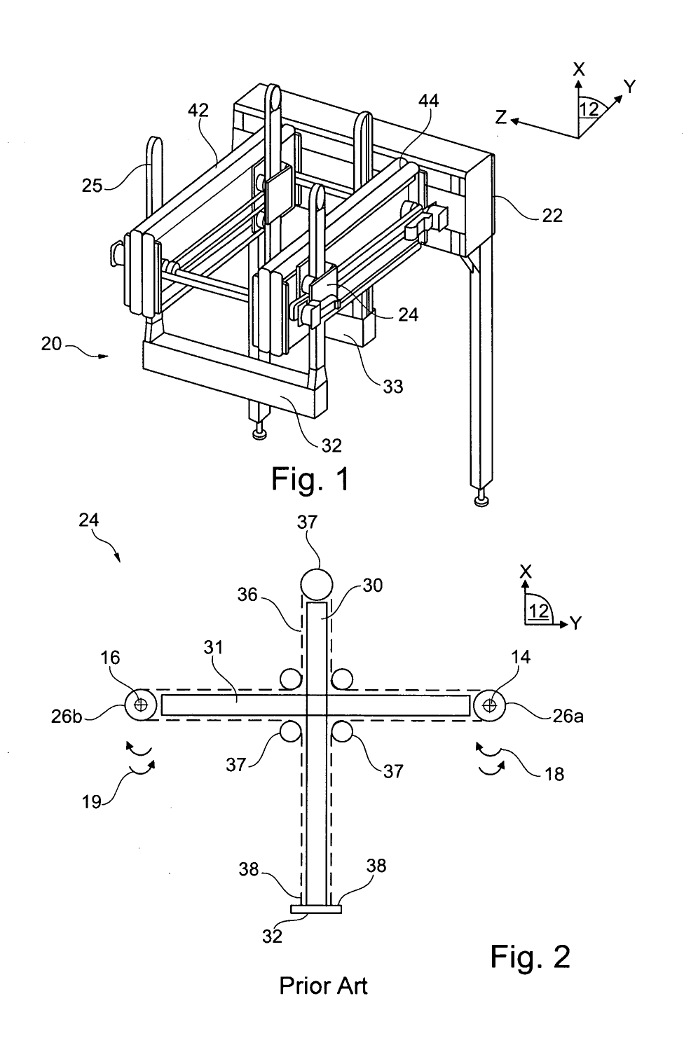

FIG. 1 shows a perspective partial view of the structure of the handling device 20 according to the invention. The basic structure of the handling device 20 is formed by the frame 22. Rails 42 and 44 to accommodate the first drive unit 24 and the second drive unit 25 are articulated on the frame 22. The first tool holder 32 is held and moved by the drive units 24 and 25. Furthermore, FIG. 1 shows a second tool holder 33. The structure of the second tool holder 33 is identical to that of the first tool holder 32. The systematic control of the drive units 24 and 25 allows the first tool holder 32 to be moved in the X and Y directions. The X and Y directions are at an angle 12 with respect to each other. In the preferred embodiment, the angle 12 is 90°. The person skilled in the art would understand that, depending on the configuration of the handling device 20, the movements of the tool holder 32 can also be at an angle 12 that differs from 90°.

A person skilled in the art would also understand that the second tool holder 33 can likewise be regulated in such a way that it can be moved in the X and Y directions.

FIG. 2 shows the schematic structure of a drive unit 24 according to the state of the art. The drive unit 24 consists of a vertical support 30 and a horizontal support 31. The tool holder 32 can be moved in the first direction X and in the second direction Y along these supports 30 and 31. The first direction X and the second direction Y are oriented at an angle 12 with respect to each other. The first motor 26a and the second motor 26b are articulated on the horizontal support 31. The first motor 26a generates a rotational movement around the first axle 14, and the second motor 26b generates a rotational movement around the second axle 16. These rotational movements are transmitted with the flexible element 36 to the tool holder 32 in order to make it move. The flexible element 36 is firmly joined to the drive unit 24 by means of the fasteners 38. The flexible element 36 runs over several deflection rollers along the outer contour of the drive unit 24. Thanks to this layout, the drive unit 24 can be moved in two spatial directions.

The vertical support 30 is moved in the second direction Y when the first motor 26a and the second motor 26b both rotate at the same rotational speed in the first rotational direction 18 or in the second rotational direction 19. The vertical support 30 is moved in the first direction X when the first motor 26a rotates in the first rotational direction 18 and when the second motor 26b rotates in the second rotational direction 19, both at the same rotational speed. An appropriate combination of the same or different rotational directions 18 and 19 as well as the rotational speed at which the first motor 26a and the second motor 26b are operated allows the tool holder 32 to be moved to any desired position of the handling device 20.

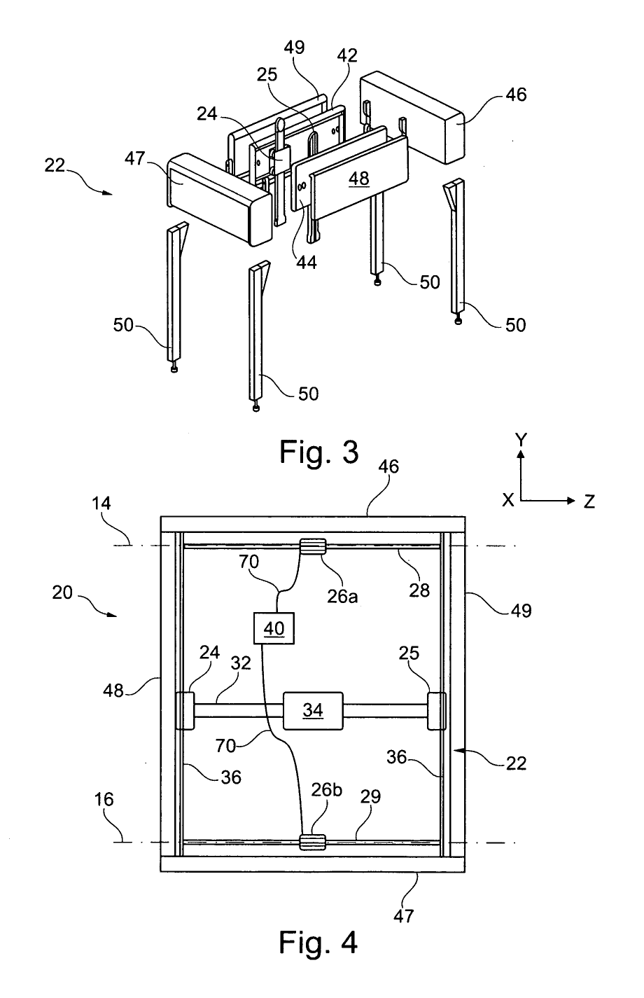

FIG. 3 shows an exploded view of the frame 22. This frame 22 includes a first main support 46 and a second main support 47 on which the first side support 48 and the second side support 49 are articulated. Moreover, two legs 50 are each attached to the first main support 46 and to the second main support 47. The first rail 42 for attaching the first drive unit 24, and the second rail 44 for attaching the second drive unit 25 can be arranged between the first side support 48 and the second side support 49.

FIG. 4 shows a top view of a handling device 20 with a first motor 26a and a second motor 26b as well as a tool holder 32. The frame 22 includes the first main support 46 and of the second main support 47 as well as of the first side support 48 and of the second side support 49. The first drive unit 24 with the associated flexible element 36 is articulated on the first side support 48. The second drive unit 25 with an associated flexible element 36 is articulated on the second side support 49. The first and second drive units 24 and 25 are driven by the first motor 26a and by the second motor 26b. The first motor 26a is connected to the first drive unit 24 and to the second drive unit 25 by the first shaft 28. The first shaft 28 is arranged coaxially around the first axle 14. The second motor 26b is connected to the first drive unit 24 and to the second drive unit 25 by the second shaft 29. The second shaft 29 is likewise arranged coaxially around the second axle 16. As a result of the fact that the first drive unit 24 and the second drive unit 25 are connected to the first motor 26a and to the second motor 26b by the first shaft 28 and by the second shaft 29, respectively, the two drive units 24 and 25 move synchronously. In order to control the first motor 26a and the second motor 26b, they are connected to a controller or device 40 via cables 70. The device 40 regulates the rotational speed and/or the rotational direction of both motors 26a and 26b in such a way that the tool holder 34 can be moved to any desired position inside the handling device 20.

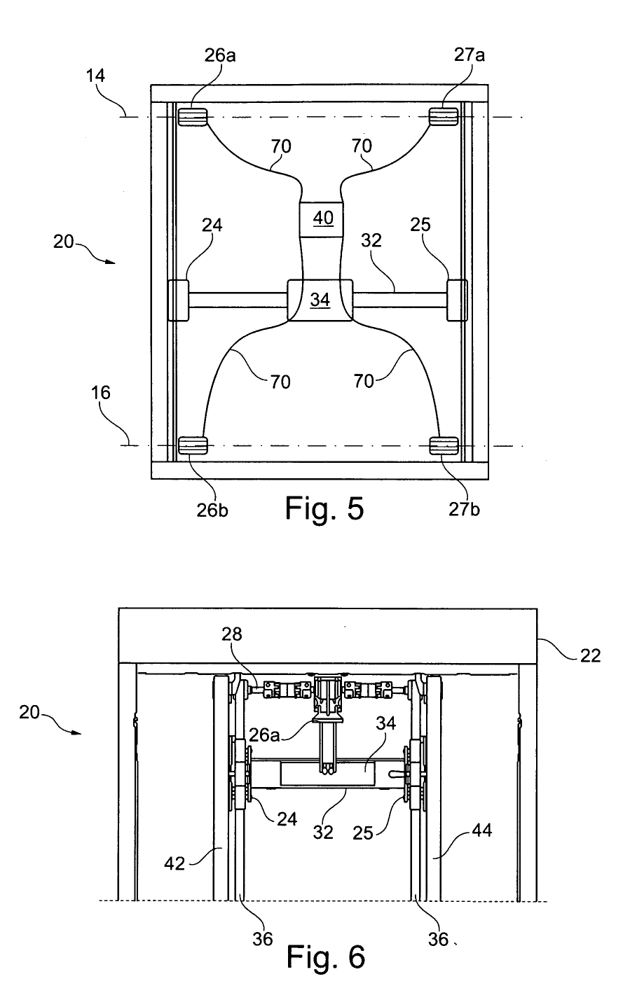

FIG. 5 shows a top view of a schematic structure of a handling device 20 with four motors 26a, 26b, 27a, 27b and one tool holder 32. The first motor 26a and the third motor 27a form a first motor pair with which the first drive unit 24 is driven. The second drive unit 25 is driven by a second motor pair that is formed by the second motor 26b and by the fourth motor 27b. The appertaining driving axle of the first motor 26a and of the third motor 27a is oriented along the first axle 14. The driving axles of the second motor 26b and of the fourth motor 27b are oriented along the second axle 16. The four motors 26a, 26b, 27a and 27b are synchronized and controlled by means of the device 40 that is connected by cables 70 to each individual motor 26a, 26b, 27a and 27b. The tool holder 32 on which the tool 34 is arranged is articulated on the first drive unit 24 and on the second drive unit 25.

FIG. 6 shows part of a handling unit 20 with two drive units 24 and 25 as well a tool holder 32. The first drive unit 24 is articulated on a first rail 42. The second drive unit 25 is articulated on a second rail 44. The first rail 42 and the second rail 44 are firmly joined to the frame 22. The first drive unit 24 and the second drive unit 25 each have a flexible element 36 and are connected to the first motor 26a via the first shaft 28. The first tool holder 32 with the tool 34 is held by the first drive unit 24 and by the second drive unit 25, and can be moved by them.

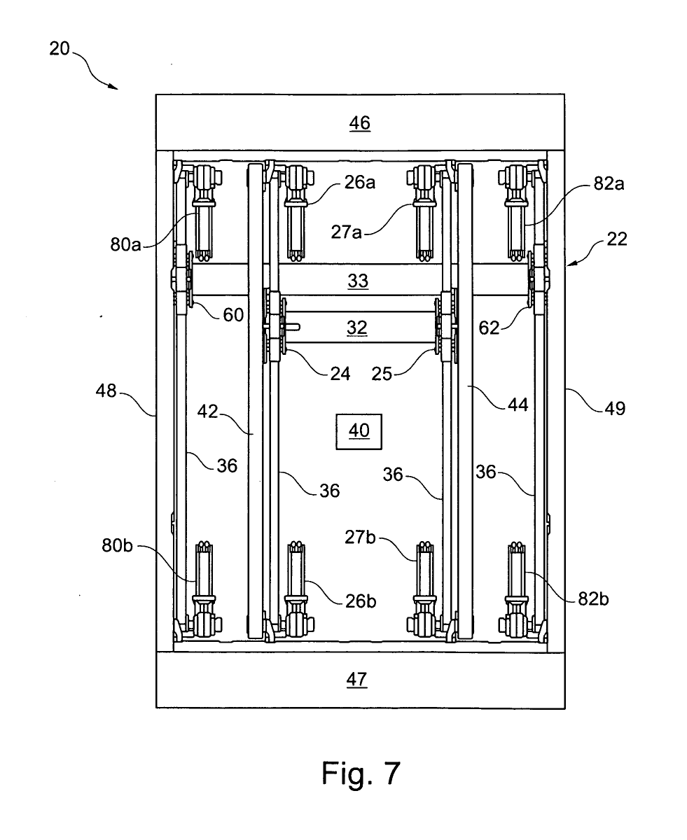

FIG. 7 shows part of a handling unit 20 with four drive units 24, 25, 60, 62 and two tool holders 32 and 33. The first tool holder 32 is articulated on the first drive unit 24 and on the second drive unit 25. The first tool holder 32 is moved by means of the flexible element 36 of the first drive unit 24 and of the second drive unit 25. The first drive unit 24 is driven by the first motor 26a and by the second motor 26b. The second drive unit 25 is driven by the third motor 27a and by the fourth motor 27b. The first drive unit 24 is affixed to the first rail 42, and the second drive unit 25 is affixed to the second rail 44. The first rail 42 and the second rail 44 are articulated on the first main support 46 and on the second main support 47 of the frame 22.

The second tool holder 33 is articulated on the third drive unit 60 and on the fourth drive unit 62. The second tool holder 33 is moved by means of the associated flexible elements 36 of the third drive unit 60 and of the fourth drive unit 62. The third drive unit 60 is driven by the fifth motor 80a and by the sixth motor 80b. The fourth drive unit 62 is driven by the seventh motor 82a and by the eighth motor 82b. The third drive unit 60 is affixed to the first side support 48 and the fourth drive unit 62 is affixed to the second side support 49.

The first motor 26a and the third motor 27a are synchronized with the device 40. Moreover, the unit 40 synchronizes the second motor 26b and the fourth motor 27b. In order to control the first tool holder 32, the first motor pair 26a and 27a as well as the second motor pair 26b and 27b are controlled by the unit 40. In order to move the second tool holder 33, the fifth motor 80a and the seventh motor 82a are synchronized using the unit 40. The unit 40 also synchronizes the sixth motor 80b and the eight motor 82b. In order to systematically move the second tool holder 33 as well, the unit 40 controls the third motor pair 80a and 82a as well as the fourth motor pair 80b and 82b.

The unit 40 also carries out the control by means of which the first tool holder 32 and the second tool holder 33 can be jointly operated in the handling device 20. In order to avoid making the depiction in FIG. 7 overly complicated, the cables 70 that connect the unit 40 to the individual motors 26a, 26b, 27a, 27b, 80a, 80b, 82a and 82b have not been shown. The person skilled in the art would understand that these cables 70 are present in a functional handling device 20. The person skilled in the art also would understand that it is also possible to operate the first tool holder 32, as shown in FIG. 4, in such a way that it is driven by two motors 26a and 26b that are connected via a shaft to the first drive unit 24 and to the second drive unit 25.

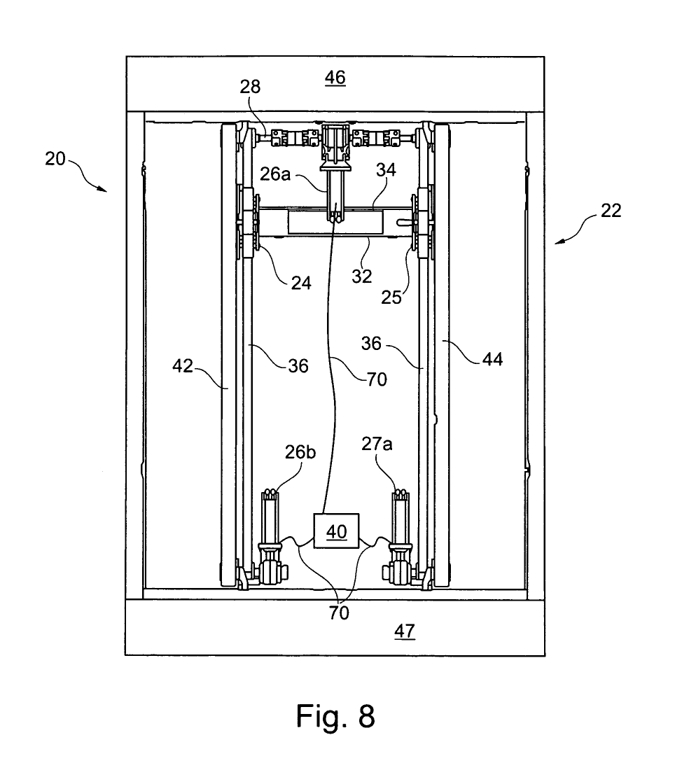

FIG. 8 shows a top view of a handling device 20 with one tool holder 32 and three motors 26a, 26b and 27a. The tool holder 32 is articulated on the first drive unit 24 and on the second drive unit 25. The tool 34 is held on the tool holder 32. The first drive unit 24 is articulated on the first rail 42, and the second drive unit 25 is articulated on the second rail 44. The first and the second rails 42 and 44 are installed on the first main support 46 and on the second main support 44 of the frame 22.

The first and the second drive units 24 and 25 each have a flexible element 36 with which the movements of the first motor 26a, of the second motor 26b and of the third motor 27a are transmitted to the tool holder 32.

In the embodiment shown in FIG. 8, the first and the second drive units 24 and 25 are driven by a first motor 26a on the side facing the first main support 46. The first and the second drive units 24 and 25 are connected to the first motor 26a by means of a first shaft 28. The first drive unit 24 and the second drive unit 25 are each driven by a motor 26b and 27a respectively on the side facing the second main support 47. The first drive unit 24 is driven by the second motor 26b, and the second drive unit 25 is driven by the third motor 27a. In order to synchronize and control the movements of the first drive unit 24 and of the second drive unit 25, the first motor 26a, the second motor 26b and the third motor 27a are connected to a device 40 via cables 70. The device 40 synchronizes the second motor 26b and the third motor 27a with each other in such a way that the first drive unit 24 and the second drive unit 25 always run synchronously. Moreover, the device 40 controls the directions of movement of the first motor 26a with the motor pair consisting of the second motor 26b and the third motor 27a, so that these motors also always move the first drive unit 24 and the second drive unit 25 in the same direction.

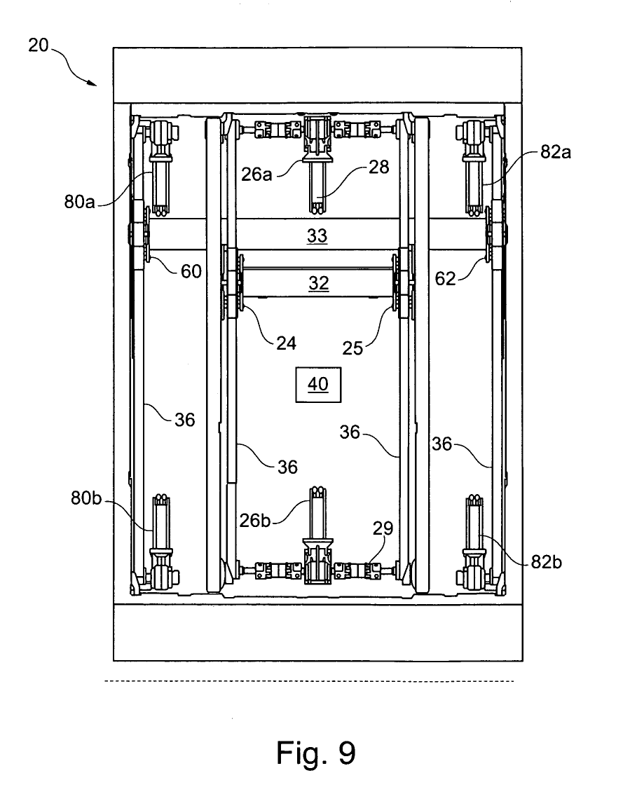

FIG. 9 shows a top view of the handling device 20 of FIG. 7 with six motors 26a, 26b, 80a, 80b, 82a and 82b. The structure of the handling device 20 and the attachment of the first tool holder 32 and of the second tool holder 33 as well as the attachment of the drive units 24, 25, 60 and 62 are shown in FIG. 7. FIG. 9 shows a first tool holder 32 that is driven by the first and second drive units 24 and 25 via flexible elements 36. The first drive unit 24 and the second drive unit 25 are driven by the first motor 26a and by the second motor 26b. The first motor 26a is connected to the first and second drive units 24 and 25 by means of a first shaft 28. The second motor 26b is connected to the first and second drive units 24 and 25 by means of a second shaft 29. The device 40 controls the movement of the first motor 26a and of the second motor 26b.

In order to move the second tool holder 33, the fifth motor 80a and the seventh motor 82a are synchronized by the unit 40. The unit 40 also synchronizes the sixth motor 80b and the eighth motor 82b. In order to also systematically move the second tool holder 33, the unit 40 controls the third motor pair consisting of the fifth motor 80a and the sixth motor 82a, as well as the fourth motor pair consisting of the sixth motor 80b and the eighth motor 82b.

The unit 40 also carries out the control by means of which the first tool holder 32 and the second tool holder 33 can be jointly moved in the handling device 20. Exactly like in FIG. 7, the cables 70 that connect the unit 40 to the six motors 26a, 26b, 80a, 80b, 82a and 82b have likewise been left out in FIG. 9 for the sake of clarity.

Different sizes can be selected for the motors 26a, 26b, 80a, 80b, 82a and 82b. Depending on the weight of the goods to be moved and on the configuration of the tool holders 32 and 33, motors with different drive outputs are needed. The first motor 26a and the second motor 26b should be dimensioned larger than the motors 80a, 80b, 80c and 80d.

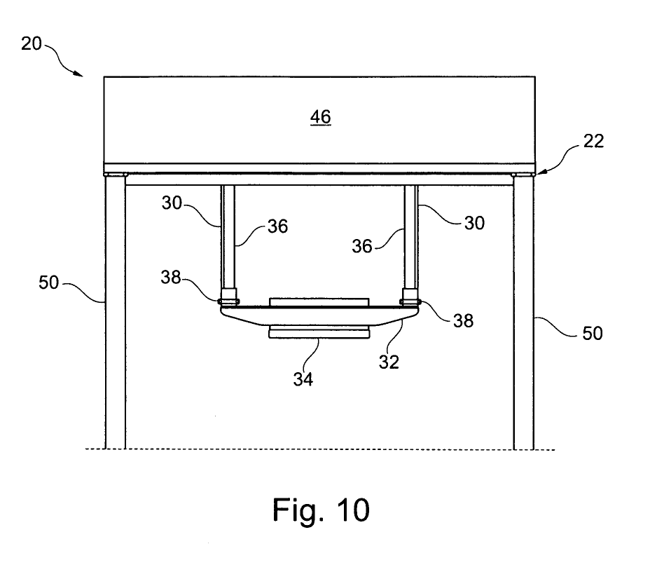

FIG. 10 shows a front view of a handling device 20 with one tool holder 32. Two legs 50 and the main support 46 of the frame 22 can be seen in this view. The first tool holder 32 with the tool 34-is likewise depicted. The first tool holder 32 is joined by means of the fasteners 38 to the two vertical supports 30 of the first drive unit 24 or of the second drive unit 25. The flexible elements 36 of the first drive unit 24 and of the second drive unit 25 are affixed to the fasteners 38.

More than two tool holders with their associated tools can be arranged in a handling device according to the invention. In this context, it is immaterial how the additional handling devices are configured. For instance, it is conceivable that a tool holder according to the invention having two drive units can be combined with a tool holder known from the state of the art, without departing from the scope of protection of the invention.

The invention was described making reference to a preferred embodiment. However, a person skilled in the art knows that variations and modifications can be made to the invention without departing from the protective scope of the claims below.

### LIST OF REFERENCE NUMERALS

10 goods

12 angle

14 first axle

16 second axle

17 third axle

18 first rotational direction

19 second rotational direction

20 handling device

22 frame

24 first drive unit

25 second drive unit

26a first motor

26b second motor

27a third motor

27b fourth motor

28 first shaft

29 second shaft

30 vertical support

31 horizontal support

32 first tool holder

33 second tool holder

34 tool

36 flexible element

37 deflection roller

38 fastener

40 device

42 first rail

44 second rail

46 first main support

47 second main support

48 first side support

49 second side support

50 legs

60 third drive unit

62 fourth drive unit

70 cables

80a fifth motor

80b sixth motor

82a seventh motor

82b eighth motor

X first direction

Y second direction

Z third direction

What is claimed is:

1. A handling device for moving goods comprising:
a first drive unit having at least one tool holder movable in two directions at an angle with respect to each other by two stationary axles in conjunction with a flexible, ribbon-shaped element; and
a second drive unit, the at least one tool holder being associated with the second drive unit in such a way that the at least one tool holder is held between the first drive unit and the second drive unit.

2. The handling device as recited in claim 1 further comprising a first motor and a second motor, the first and the second drive units each drivable by the first motor and the second motor.

3. The handling device as recited in claim 2 wherein the first motor and the second motor are arranged in such a way that the stationary axles of the first drive unit, and further stationary axles of the second drive unit are connected to each other by a shared first shaft and a shared second shaft, the shared first shaft drivable by the first motor and the shared second shaft drivable by the second motor.

4. The handling device as recited in claim 3 further comprising a controller regulating the first motor and the second motor in terms of their rotational speed and rotational direction.

5. The handling device as recited in claim 2 further comprising a third motor arranged in such a way that a first stationary axle of the stationary axles of first drive unit and a further stationary axle of the second drive unit are connected to each other by a shared first shaft, and the shared first shaft drivable by the first motor, the second and third motors acting on a second stationary axle of the stationary axles of the first drive unit, so that the first drive unit can be driven by the second motor and the second drive unit can be driven by the third motor.

6. The handling device as recited in claim 5 further comprising a controller regulating the first motor as well as a motor pair defined by the second motor and the third motor so that the second motor and the third motor can be synchronized using the unit in such a way that the at least one tool holder can be moved in the two directions that are at an angle with respect to each other.

7. The handling device as recited in claim 2 further comprising a third and a fourth motor, the first motor and the second motor acting on a first stationary axle of the stationary axles and on a second stationary axle of the stationary axles of the first drive unit, respectively, the third motor and the fourth motor acting on a further second stationary axle and on a further first stationary axle of the second drive unit, respectively, so that the first drive unit can be driven by the first motor and the second motor, and the second drive unit can be driven by the fourth motor and the third motor.

8. The handling device as recited in claim 7 further comprising a controller synchronizing the first motor and the fourth motor to define a first motor pair as well as the second motor and the third motor to define a second motor pair, and regulating the first motor and the fourth motor of the first motor pair as well as the second motor and the third motor of the second motor pair in terms of rotational speed and rotational direction.

9. The handling device as recited in claim 1 wherein each of the first and second drive units is held on a first rail and on a second rail.

10. The handling device as recited in claim 9 wherein the first and second rails are articulated on a frame of the handling unit.

11. The handling device as recited in claim 1 the at least one tool holder includes at least two tool holders, each of the two tool holders having at two drive units associated therewith.
